(19) United States
(12) Patent Application Publication
(10) Pub. No.: US 2026/0298711 A1
(43) Pub. Date: Oct. 1, 2026

(54) SPECTROMETER

(71) Applicant: SEIKO EPSON CORPORATION, TOKYO (JP)

(72) Inventors: Ayano NAKAMURA, SHIOJIRI-SHI (JP); Akira SANO, Matsumoto-shi (JP)

(21) Appl. No.: 19/632,941

(22) Filed: Mar. 30, 2026

(30) Foreign Application Priority Data
Mar. 28, 2025 (JP) 2025-055267

(51) Int. Cl. G01J 3/28; G01J 3/02

(52) U.S. Cl. CPC G01J 3/2823; G01J 3/0267; G01J 3/0275

(57) ABSTRACT

A spectrometer includes a spectroscopic element, an element control section that controls an operation of the spectroscopic element, an imager that acquires a plurality of spectral images at acquisition timings different from each other, a shift amount acquisition section that acquires a relative positional shift amount between a first spectral image, which is one of the plurality of spectral images, and a second spectral image, which is another one of the plurality of spectral images, using information regarding relative movement, and an alignment section that performs positioning between the first spectral image and the second spectral image by correcting a position of the second spectral image with respect to a position of the first spectral image using the positional shift amount acquired by the shift amount acquisition section.

The present application is based on, and claims priority from JP Application Serial Number 2025-055267, filed Mar. 28, 2025, the disclosure of which is hereby incorporated by reference herein in its entirety.

### BACKGROUND

### 1. Technical Field

The present disclosure relates to a spectrometer.

### 2. Related Art

In the related art, a spectrometer is known that changes a wavelength of light to be transmitted and acquires a spectral image of a target for each wavelength of light (for example, JP-A-06-18329 and JP-A-2022-98668).

In the related art, when a plurality of spectral images are acquired from a target while the spectrometer and the target are relatively moved, a positional shift amount in the target image may occur between the plurality of spectral images. There is a desire for a technique capable of more easily and accurately correcting a positional shift amount in a plurality of spectral images.

### SUMMARY

According to an aspect of the present disclosure, a spectrometer is provided. The spectrometer includes a spectroscopic element configured to change a wavelength of light to be transmitted and to spectrally disperse light from a target; an element control section configured to control operation of the spectroscopic element; an imager configured to receive the light transmitted through the spectroscopic element and to acquire at least one spectral image for each of a plurality of the wavelengths obtained by spectral dispersion, the imager acquiring a plurality of spectral images corresponding to the plurality of wavelengths for a target that moves relative to the imager at acquisition timings different from each other; a shift amount acquisition section configured to, using information on the relative movement, acquire a relative positional shift amount between a first spectral image that is one of the plurality of spectral images and a second spectral image that is another one of the plurality of spectral images; and a position alignment section configured to perform, using the positional shift amount acquired by the shift amount acquisition section, position alignment between the first spectral image and the second spectral image by correcting a position of the second spectral image with respect to a position of the first spectral image.

### BRIEF DESCRIPTION OF THE DRAWINGS

FIG. 1 is a diagram for explaining a spectrometer system according to an embodiment.

FIG. 2 is a schematic diagram of the spectroscopic element as viewed from a second substrate side.

FIG. 3 is a cross-sectional view taken along line III-III of FIG. 2.

FIG. 4 is a diagram for explaining a control section.

FIG. 5 is a flowchart illustrating a spectral image generation process performed by a spectrometer.

FIG. 6 is a diagram for explaining a generation process.

FIG. 7 is a diagram for explaining a control section according to a first other embodiment.

FIG. 8 is a diagram for explaining the first other embodiment.

FIG. 9 is a flowchart of step S50 according to the first other embodiment.

### DESCRIPTION OF EMBODIMENTS

### A. Embodiment

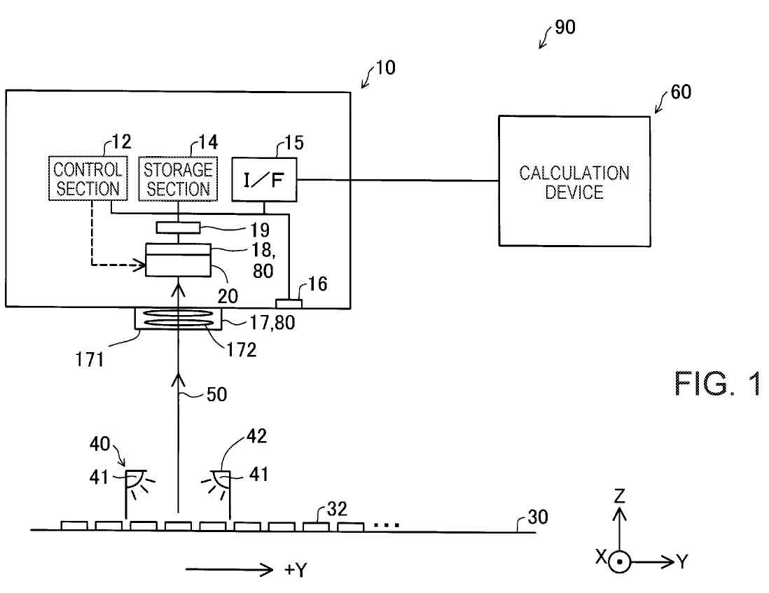

FIG. 1 is a diagram for explaining a spectrometer system 90 according to an embodiment. FIG. 1 includes an X-axis, a Y-axis, and a Z-axis that are orthogonal to each other. A Z direction along the Z axis is a vertical direction, and a +Z direction is an upward direction. Note that the X axis, the Y axis, and the Z axis corresponding to those in FIG. 1 are also included in the other drawings as necessary. The spectrometer system 90 includes a spectrometer 10 that acquires a spectral image, a measurement auxiliary device 40, a transport section 30, and a calculation device 60.

The transport section 30 is a constant velocity conveyor that moves the plurality of targets 32 in a fixed direction. The transport section 30 of the present embodiment moves the plurality of targets 32 in the +Y direction along the horizontal direction at a constant speed. The target 32 is, for example, an industrial product before shipment, which is inspected for defects. Note that in another embodiment, the target 32 may be any target from which a spectral image is acquired, and may be a target such as an agricultural product, a mineral, or printed matter.

The measurement auxiliary device 40 is disposed on the transport line of the transport section 30. The measurement auxiliary device 40 includes a housing 42 and a light source device 41. The measurement auxiliary device 40 irradiates the target 32 with light in order to acquire a spectral image by the spectrometer 10. The housing 42 is formed of, for example, a light shielding member that shields out external light. The housing 42 has an entrance opening through which the target 32 moving on the transport section 30 enters and an exit opening through which the target 32 that has entered exits. An upper opening for causing the reflected light 50, which is light from the target 32, to travel toward the spectrometer 10 is formed in an upper section of the housing 42. A plurality of light source devices 41 are provided in the housing 42 so that at least the entire upper surface of the target 32 is irradiated. Note that the number of light source devices 41 may be one. As the light source device 41, for example, an incandescent lamp such as a halogen lamp or an infrared ray lamp is used. The light source device 41 may be controlled by the spectrometer 10.

The spectrometer 10 is a Fabry-Perot type spectroscopic camera. The spectrometer 10 includes an optical system 17, a spectroscopic element 20, an imaging element 18, an amplification section 19, a control section 12, a storage section 14, an interface 15, and a physical quantity sensor 16. The position of the spectrometer 10 is fixed directly above the measurement auxiliary device 40.

The optical system 17 is an optical system that guides the incident reflected light 50 to the spectroscopic element 20. The optical system 5 includes a shutter 171 that is controlled to open and close and an optical component 172 including one or more lenses. The optical component 172 emits the incident reflected light 50 so as to be orthogonal to a first substrate (to be described later) of the spectroscopic element 20. In the present embodiment, the optical axis of the optical system 17 is in the Z direction and is perpendicular to the movement direction of the target 32.

The spectroscopic element 20 is also called a variable wavelength interference filter and is an etalon. The spectroscopic element 20 changes the wavelength of the light transmitted therethrough and spectrally disperses the reflected light 50, which is the light from the target 32. Specifically, the spectroscopic element 20 transmits light of a target wavelength λ from the incident light from the target 32, which has components of various wavelengths, by adjusting a gap dimension, which is a dimension of a gap Gp (to be described later). Target wavelength λ means a wavelength at which the transmittance of the spectroscopic element 20 is maximized. That is, the spectroscopic element 20 transmits light having a wavelength in a predetermined range centered on the wavelength λ. The spectroscopic element 20 will be described in detail later.

The imaging element 18 is disposed so as to be located on a focal plane of the optical system 31. The reflected light 50 from the target 32 passes through the optical system 17 and, of the light that passed, the light transmitted through the spectroscopic element 20 is detected by the imaging element 18. The imaging element 18 includes a plurality of detection elements arranged in an array. The plurality of detection elements each constitute a pixel, and are constituted by a photoelectric conversion element such as a charge coupled device (CCD) element or a complementary metal oxide semiconductor (CMOS). Each of the plurality of detection elements generates an electric signal corresponding to the amount of received light and outputs the electric signal to a light amount acquisition section (to be described later) via the amplification section 19.

The amplification section 19 adjusts the gain in accordance with a command from the control section 12 and, by this, adjusts the gain of the electrical signal generated by the imaging element 18. The electric signal after gain adjustment is output to a photoelectric acquisition section (to be described later) of the control section 12.

The control section 12 controls operation of the spectrometer 10. For example, the control section 12 controls a gap dimension (to be described later) of the spectroscopic element 20. Details of the control section 12 will be described later.

The storage section 14 is configured by a memory such as a ROM or a RAN. The storage section 14 stores various programs for controlling the operation of the spectrometer 10.

The interface 15 is an interface for exchanging data with an external device. The interface 15 performs data communication with an external device in a wired or wireless manner.

The physical quantity sensor 16 detects a physical quantity representing relative movement of the target 32 that performs relative movement with respect to the imaging element 18, which constitutes the imager. In the present embodiment, the physical quantity sensor 16 is a speed sensor that detects the speed of the target 32. Note that in another embodiment, the physical quantity sensor 16 may be a sensor capable of detecting a movement direction or acceleration in addition to the movement speed of the target 32.

The calculation device 60 is an electronic computer such as a personal computer. The calculation device 60 is connected to the spectrometer 10 so as to be capable of data communication. The calculation device 60 includes a display section such as a liquid crystal monitor. The calculation device 60 inspects the target 32 using the spectral image of the target 32 acquired from the spectrometer 10. The calculation device 60 displays the spectral image and the inspection result of the target 32 on the display section. Note that the spectrometer 10 may have at least a part of the functions of the calculation device 60.

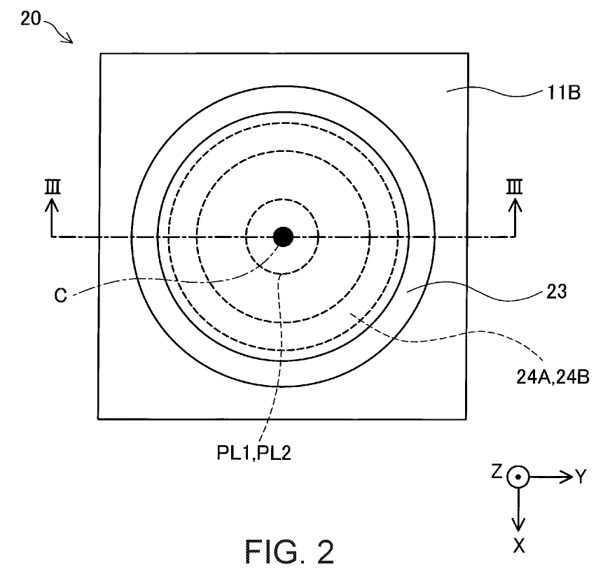

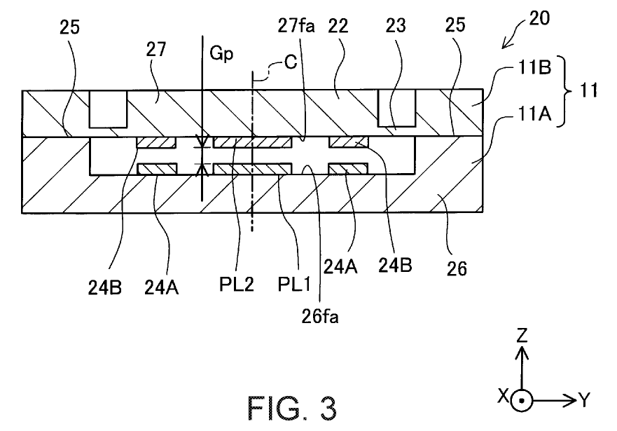

FIG. 2 is a diagram schematically illustrating the spectroscopic element 20 as viewed from the second substrate 11B side. FIG. 3 is a cross-sectional view taken along line III-III of FIG. 2. As shown in FIGS. 2 and 3, the spectroscopic element 20 is an optical member having a substantially rectangular parallelepiped shape. As illustrated in FIG. 3, the spectroscopic element 20 includes a first substrate 11A as a fixed substrate and a second substrate 11B as a movable substrate facing the first substrate 11A in the Z direction. The first substrate 11A and the second substrate 11B constitute a substrate pair 11. By adjusting the gap dimension (to be described later) of the spectroscopic element 20, of the light having components of various wavelengths that was incident on the spectroscopic element 20, the light having a target wavelength is transmitted. FIGS. 2 and 3 illustrate a reference condition in which no voltage is applied between a first drive electrode 24A and a second drive electrode 24B of the spectroscopic element 20 and in which the gap dimension is a reference dimension. In the following description, the configuration of the spectroscopic element 20 is described on the premise of the reference state.

The first substrate 11A includes a first main body 26, a first reflective film PL1, and first drive electrode 24A. The second substrate 11B includes a second main body 27, a second reflective film PL2, and the second drive electrode 24B. The second main body 27 includes a movable section 22 and a holding section 23. The first substrate 11A and the second substrate 11B are integrally formed by being joined by a joining section 25. The first main body 26 and the second main body 27 are each made of a material that transmits light, such as various types of glass or quartz crystal. The first reflective film PL1 and the second reflective film PL2 are films having a reflective function and a transmissive function. The first reflective film PL1 and the second reflective film PL2 are, for example, metallic film such as a Ag or a conductive alloyed film such as an Ag alloyed film. The joining section 25 is formed of a plasma polymerized film or the like containing siloxane as a main component. The joining section 25 is generated by activating a part of the first main body 26 and the second main body 27 with plasma to form a plasma polymerized film.

The first reflective film PL1 is a substantially circular film through which passes a central axis C of the spectroscopic element 20. The first reflective film PL1 is disposed on a surface 26fa of the first main body 26 that faces the second substrate 11B. The first drive electrode 24A has a constant width and is annular shaped centered on the central axis C. The first drive electrode 24A is disposed so as to surround the first reflective film PL1 in plan view.

The movable section 22 of the second main body 27 is a cylindrical member passing through the central axis C. The holding section 23 is provided outside the movable section 22 and is connected to the movable section 22. The holding section 23 is formed so as to surround the movable section 22. The holding section 23 is configured to be elastically deformable with a thickness smaller than that of the movable section 22.

The second reflective film PL2 is a substantially circular film through which passes the central axis C of the spectroscopic element 20. The second reflective film PL2 is disposed on a surface 27fa of the second main body 27 that faces the first substrate 11A. The second reflective film PL2 faces the first reflective film PL1 in the Z-direction as the first direction via the gap Gp. The second drive electrode 24B has a constant width and is annular shaped centered on the central axis C. The second drive electrode 24B is disposed so as to surround the second reflective film PL2 in plan view. The second drive electrode 24B faces the first drive electrode 24A in the Z direction. The second reflective film PL2 and the second drive electrode 24B are disposed in a range overlapping the movable section 22 in plan view. The joining section 25 is formed on the surface 26fa and the surface 27fa and is formed so as to surround the first reflective film PL1, the second reflective film PL2, the first drive electrode 24A, and the second drive electrode 24B in plan view.

The first drive electrode 24A and the second drive electrode 24B are connected to the control section 12 via electric lines. For example, the first drive electrode 24A and the second drive electrode 24B are electrically connected to the control section 12 via electric wires or the like disposed in grooves or through holes (not shown) formed in the first main body 26 and the second main body 27. When a drive voltage is applied between the first drive electrode 24A and the second drive electrode 24B from the control section 12, an electrostatic attractive force is generated according to the voltage value of the drive voltage. The holding section 23 is elastically deformed by the electrostatic attractive force and, by this, the movable section 22 can be displaced toward the first substrate 11A side. The gap dimension in the Z direction is set as the first direction of the gap Gp according to displacement of the movable section 22 toward the first substrate 11A side. That is, the spectroscopic element 20 can change the gap dimension by displacing, in the Z direction, the second reflective film PL2, which is disposed on the movable section 22. As described above, the dimension of the gap Gp in the Z-direction is changed according to the value of the drive voltage applied between the first drive electrode 24A and the second drive electrode 24B. By changing the gap dimension, the wavelengths of light transmitted through the first main body 26, the first reflective film PL1, the second reflective film PL2, and the second main body 27 can be changed. Of the light incident from the first main body 26 side of the first substrate 11A, light of the measurement wavelength as the target wavelength is emitted from the movable section 22 of the second substrate 11B.

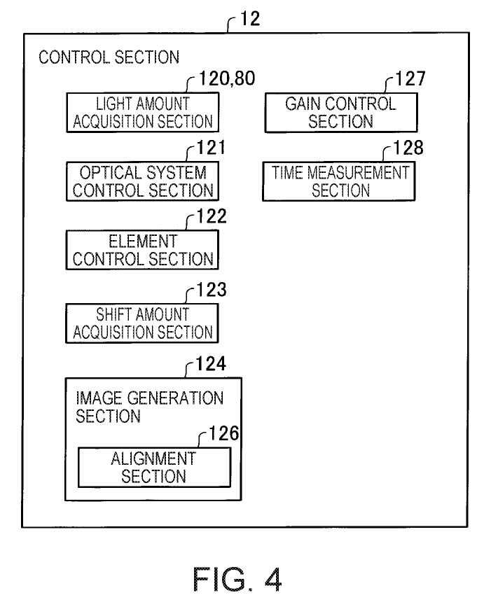

FIG. 4 is a diagram for explaining the control section 12. By executing the program in the storage section 14, the control section 12 functions as a light amount acquisition section 120, an optical system control section 121, an element control section 122, a shift amount acquisition section 123, an image generation section 124, a gain control section 127, and a time measurement section 128. Note that at least a part of the functions executed by the control section 12 may be implemented by hardware.

The light amount acquisition section 120 acquires an electric signal output from the imaging element 18. The light amount acquisition section 120 generates a spectral image by associating the acquired received light amount with the coordinate value of each pixel of the imaging element 18. The light amount acquisition section 120 stores the generated spectral image and the wavelength λ of the light transmitted through the spectroscopic element 20, which is the generation source of the spectral image, in the storage section 14 in association with each other. The optical system 17, the imaging element 18, the amplification section 19, and the light amount acquisition section 120 constitute an imager 80. As described above, the imager 80 receives the light transmitted through the spectroscopic element 20 and acquires at least one spectral image for each of the plurality of spectrally dispersed wavelengths λ. The imager 80 acquires, at different timings, a plurality of spectral images corresponding to a plurality of wavelengths λ with respect to the target 32, which is moving relative to the imager 80. In the present embodiment, the relative movement is movement in the +Y direction, which is one direction orthogonal to the vertical direction, while maintaining a constant distance in the vertical direction between the spectrometer 10 (including the imager 80) and the target 32.

The optical system control section 121 controls operation of the optical system 5. For example, the optical system control section 121 controls the exposure time by controlling the opening and closing of the shutter 171. For example, the optical system control section 121 adjusts the position of the optical component 172 to adjust the focal distance.

The element control section 122 controls the operation of the spectroscopic element 20. Specifically, the element control section 122 controls the operation of the spectroscopic element 20 by applying, to the spectroscopic element 20, a drive voltage corresponding to a measurement wavelength λ, which is the wavelength λ of light transmitted through the spectroscopic element 20. The correspondence relationship between the plurality of measurement wavelengths λ and the drive voltages is stored in the storage section 14.

The shift amount acquisition section 123 acquires the relative positional shift amount Dd of the target 32 between the plurality of spectral images using information regarding the relative movement between the imager 80 and the target 32. Specifically, the shift amount acquisition section 123 acquires the relative positional shift amount of the images of the target 32 between the first spectral image and the second spectral image. The first spectral image and the second spectral image are acquired at different acquisition timings. The first spectral image is one of the plurality of spectral images. The second spectral image is another one of the plurality of spectral images. In the present embodiment, the shift amount acquisition section 123 acquires the positional shift amount Dd using the movement speed V of the target 32, which is a physical quantity detected by the physical quantity sensor 16, and the time difference Δt between the acquisition timings of the first spectral image and the second spectral image. The shift amount acquisition section 123 acquires the positional shift amount Dd by multiplying the movement speed V of the target 32 by the time difference Δt. The acquired positional shift amount Dd is stored in the storage section 14 together with vector information indicating the direction of the positional shift amount. The vector information may be acquired as the movement direction of the target 32 by the physical quantity sensor 16, or may be acquired by storing in advance the transport direction of the target 32 by the transport section 30 in the storage section 14. The positional shift amount Dd acquired by the shift amount acquisition section 123 is stored in the storage section 14 together with an identifier for identifying a set of the first spectral image and the second spectral image from which the positional shift amount Dd is calculated.

The image generation section 124 performs image processing such as position correction of the spectral image. The image generation section 124 includes an alignment section 126 that aligns a plurality of spectral images using the positional shift amount Dd from the acquired spectral images. The alignment section 126 performs alignment between the first spectral image and the second spectral image by using the positional shift amount Dd acquired by the shift amount acquisition section 123 to correct the position of the second spectral image with respect to the position of the first spectral image so as to eliminate the positional shift amount Dd. In the present embodiment, the alignment section 126 performs the alignment between the first spectral image and the second spectral image by performing correction of translating each pixel of the second spectral image in the direction opposite to the movement direction of the target 32 by a pixel amount corresponding to the positional shift amount Dd.

The gain control section 127 controls the amplification factor of the amplification section 19 illustrated in FIG. 1. The amplification factor is a factor for amplifying the intensity of an electric signal that represents a signal of light received by the imaging element 18. The gain control section 127 may determine the amplification factor using, for example, an amplification factor table that defines the amplification factor for each of the plurality of wavelengths λ of light. In the amplification factor table, the amplification factor is determined so as to reduce the difference in luminance between the plurality of spectral images for each of the plurality of wavelengths λ that were obtained by spectral dispersion by the spectroscopic element 20. Luminance of the spectral image is an average value of the luminance of the pixels in the spectral image. The amplification factor table is stored in the storage section 14, for example. For example, the amplification factor table may be a table that defines relationships between exposure time and the amplification factor.

The time measurement section 128 has a function as a timer that measures the current time. The time measurement section 128 measures the time of the acquisition timing at which the imager 80 acquires spectral images. The time measurement section 128 has a function of detecting a time difference between two acquisition timings among the plurality of measured acquisition timings.

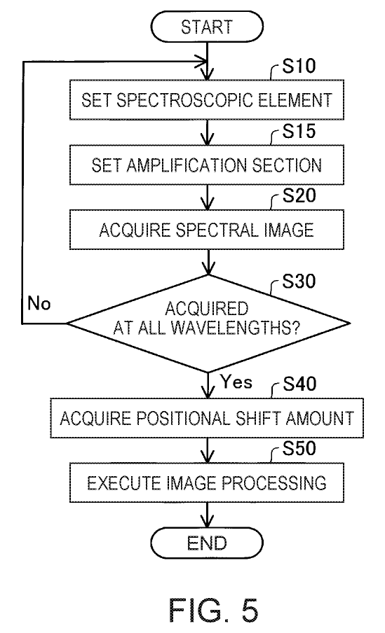

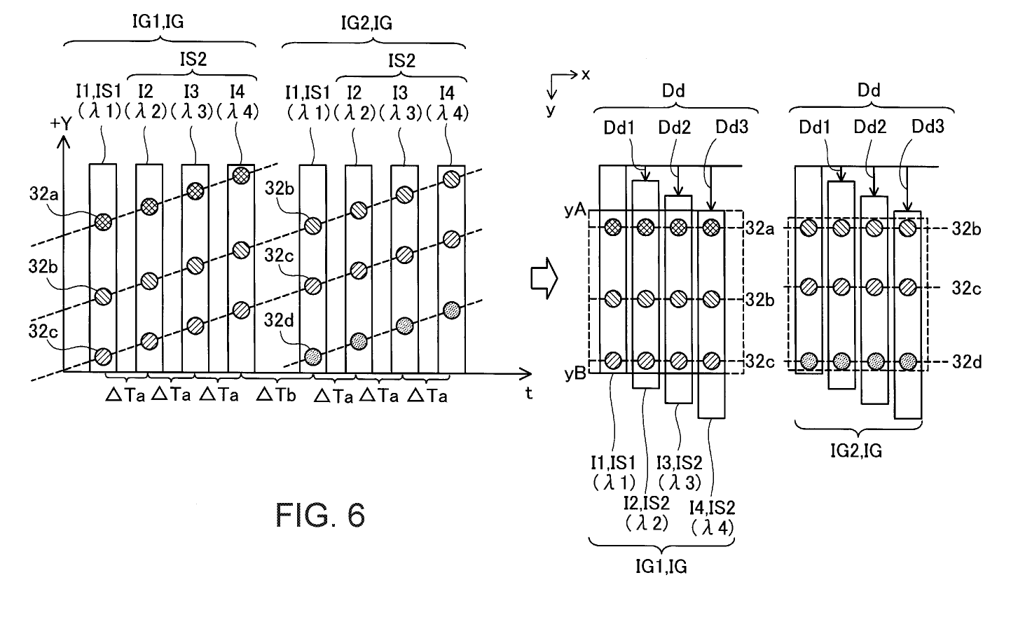

FIG. 5 is a flowchart illustrating a process performed by the spectrometer 10 in generating a spectral image. FIG. 6 is a diagram for explaining the generation process. In the present embodiment, an example will be described of a case where a plurality of spectral images are acquired by changing the wavelength λ of the light transmitted in a range where the gap dimension is equal to or greater than a first distance and equal to or less than a second distance. In particular, in the present embodiment, an example will be described in which four spectral images I1, I2, I3, I4 corresponding to four measurement wavelengths λ1, λ2, λ3, λ4 are acquired for the same target 32. The gap dimensions in the spectroscopic element 20 are the gap dimension G1 at the measurement wavelength λ1, the gap dimension G2 at the measurement wavelength λ2, the gap dimension G3 at the measurement wavelength λ3, and the gap dimension G4 at the measurement wavelength λ4. The magnitude relationship between the gap dimensions G1 to G4 is G1> G2> G3> G4. The gap dimension G1 is the second distance and the gap dimension G4 is the first distance.

As illustrated in FIG. 5, in step S10, the element control section 122 applies a drive voltage between the first drive electrode 24A and the second drive electrode 24B so as to obtain a gap dimension corresponding to the measurement wavelength λ amongst the plurality of measurement wavelengths λ1 to λ4. Next, in step S15, the gain control section 127 sets the amplification factor in the amplification section 19 according to the measurement wavelength λ so as to reduce the difference in luminance of the plurality of spectral images I1 to I4 for each of the plurality of measurement wavelengths λ1 to λ4. Note that the order of step S10 and step S15 is not limited to this, and may be reversed.

Next, in step S20, the imager 80 of the spectrometer 10 causes the reflected light 50 from three targets 32 in the housing 42 illustrated in FIG. 1 to be incident on the spectroscopic element 20, and causes the light of the measurement wavelength λ to be transmitted. The imager 80 receives the transmitted light of the measurement wavelengths λ at step S20 and, by this, acquires a spectral image. Note that in the present embodiment, three targets 32 are imaged in one spectral image, but in another embodiment, spectral images I1 to I4 of measurement wavelengths λ1 to λ4 may be acquired for each target 32. The acquired spectral images I1 to I4 are stored in the storage section 14. Note that in the present embodiment, the exposure time by the imager 80 is constant regardless of the measurement wavelengths λ1 to λ4.

In step S30, the control section 12 determines whether or not a spectral image I has been acquired at all of the plurality of measurement wavelengths λ1 to λ4. When at least one of all the spectral images has not been acquired, the spectrometer 10 repeatedly executes step S10 to step S20 for the measurement wavelengths λ corresponding to the spectral images that have not been acquired.

When the control section 12 determines in step S30 that the spectral images have been acquired at all of the plurality of measurement wavelengths λ1 to λ4, then in step S40 the control section 12 acquires the positional shift amount Dd between two spectral images among the plurality of spectral images.

As shown in FIG. 6, the method of acquiring the positional shift amount Dd will be described using an example in which four spectral images I1 to I4 corresponding to four measurement wavelengths λ1 to λ4 are acquired for the same target 32. A group of spectral images I1 to I4 obtained by collectively imaging the targets 32a, 32b, and 32c is also referred to as a first image group IG1. A group of spectral images I1 to I4 obtained by collectively imaging the targets 32b, 32c, and 32d is also referred to as a second image group IG2. In this way, the spectral images I1 to I4 corresponding to the plurality of measurement wavelengths λ1 to λ4 for the same target 32 are referred to as an image group IG. In a case where the spectral images I1, I2, I3, and I4 are acquired in the order of the measurement wavelengths λ1, λ2, λ3, and λ4, it is assumed that there is a time of Δta for changing the gap dimension to switch the measurement wavelengths. When the second image group IG2 is acquired after the first image group IG1 is acquired, it is assumed that there is a time Δtb for switching from the gap dimension G4 corresponding to the measurement wavelength λ4 to the gap dimension G1 corresponding to the measurement wavelength λ1.

The shift amount acquisition section 123 sets, as a first spectral image IS1, the spectral image I1 acquired first amongst one image group IG obtained by imaging the same target 32, sets the remaining spectral images I2, I3, and I4 as second spectral images IS2, and acquires a positional shift amount Dd of the second spectral image IS2 with respect to the position of the first spectral image IS1. Note that the first spectral image IS1 may not be the spectral image I1 acquired first and may be, for example, the spectral image I4 acquired last or may be the spectral image IN acquired the N-th time. The shift amount acquisition section 123 acquires the positional shift amount Dd using the movement speed V of the target 32 acquired by the physical quantity sensor 16 and the time difference ΔT between the acquisition timing of the first spectral image IS1 and the acquisition timing of the second spectral image IS2. The shift amount acquisition section 123 acquires the positional shift amount Dd by multiplying the movement speed V by the time difference ΔT. For example, in the first image group IG1, the positional shift amount Dd1 between the first spectral image I1 corresponding to the measurement wavelength λ1 and the second spectral image I2 corresponding to the measurement wavelength λ2 is obtained by multiplying the movement speed V by the time difference ΔTa. The time difference ΔTa is a time difference between the acquisition timing of the first spectral image I1 and the acquisition timing of the second spectral image I2. In the first image group IG1, the positional shift amount Dd2 between the first spectral image I1 corresponding to the measurement wavelength λ1 and the second spectral image I3 corresponding to the measurement wavelength λ3 is obtained by multiplying the movement speed V by a time difference Δ2 · Ta. The time difference Δ2 · Ta is the time difference between the acquisition timing of the first spectral image I1 and the acquisition timing of the second spectral image I3. In the first image group IG1, the positional shift amount Dd3 between the first spectral image I1 corresponding to the measurement wavelength λ1 and the second spectral image I4 corresponding to the measurement wavelength λ4 is obtained by multiplying the movement speed V by a time difference Δ3 · Ta. The time difference Δ3 · Ta is the time difference between the acquisition timing of the first spectral image I1 and the acquisition timing of the second spectral image I4.

As illustrated in FIG. 5, in step S50 after step S40, the alignment section 126 executes image processing that uses the acquired positional shift amounts Dd1 to Dd3 and the vector information indicating the direction of the positional shift to correct the position of the second spectral image IS2 so that the positional shift of the second spectral image IS2 with respect to the first spectral image IS1 is eliminated. By this, in step S50, the alignment section 126 performs alignment between the first spectral image IS1 and the second spectral image IS2 so that the pixel position of one target 32 in the first spectral image IS1 and the pixel position of the one target 32 in the second spectral image IS2 are the same.

In detail, as illustrated in the righthand part of FIG. 6, the alignment section 126 performs correction of translating each pixel of the second spectral image IS2 by a pixel amount corresponding to the positional shift amount Dd. For example, the alignment section 126 performs alignment by translating, in the direction opposite to the movement direction of the target 32, the spectral image I2 of the first image group IG1 by a pixel amount corresponding to the positional shift amount Dd1. For example, the alignment section 126 performs alignment by translating, in the direction opposite to the movement direction of the target 32, the spectral image I3 of the first image group IG1 by a pixel amount corresponding to the positional shift amount Dd3. For example, the alignment section 126 performs alignment by translating, in the direction opposite to the movement direction of the target 32, the spectral image I4 of the first image group IG1 by a pixel amount corresponding to the positional shift amount Dd3. In the present embodiment, the direction opposite to the movement direction of the target 32 is the +y-axis direction in the image coordinate system represented by the x axis and the y axis.

In step S50 illustrated in FIG. 5, the alignment section 126 performs a process of extracting a region in which the target 32 is included, for the spectral images I1 to I4 after alignment, and stores the extracted spectral images I1 to I4 in the storage section 14. By this, step S50 for the first image group IG1 is completed. The spectrometer 10 repeatedly executes the processes of step S10 to step S50 on the target image group IG. In the present embodiment, the extracted region is a range in which the y coordinates of the image are yA to yB as illustrated in the right diagram of FIG. 6. Note that the alignment section 126 may set predetermined pixel values, for example, pixel values of a white image, in a pixel region in which the target 32 or the image of the background is not present in the image as a result of performing the image processing of the alignment in the spectral image I1.

According to the embodiment, as illustrated in FIGS. 5 and 6, the spectrometer 10 acquires the relative positional shift amount Dd using the information regarding the relative movement, and corrects the position of the second spectral image IS2 with respect to the position of the first spectral image IS1 using the acquired positional shift amount Dd. By this, it is possible to easily and accurately correct the positional shift amount of the second spectral image IS2 with respect to the first spectral image IS1. Since the positional shift amount Dd can be acquired regardless of the size of the measurement wavelength range, which is the width of the wavelength transmitted through the spectroscopic element 20, a clear spectral image of the measurement wavelength λ can be acquired by narrowing the measurement wavelength range. According to the above embodiment, the spectral image for each measurement wavelength λ can be acquired even in a case other than the case where the target 32 moves relative to the imager 80. For example, in a case where the target 32 is stationary with respect to the imager 80, the spectrometer 10 can acquire a spectral image for each measurement wavelength λ by setting the positional shift amount Dd to zero. Since the positional shift amount of the second spectral image IS2 with respect to the first spectral image IS1 can be corrected with high accuracy, it is possible to easily generate a spectrum representing information on the received light amount of light for each of the measurement wavelengths λ of the respective pixels.

According to the embodiment, the amplification factor of the amplification section 19 is determined so as to reduce the difference in luminance between the plurality of spectral images for each of the plurality of wavelengths λ that were spectrally dispersed by the spectroscopic element 20 and, by this, the difference in luminance between the plurality of spectral images can be reduced. According to the embodiment, the positional shift amount Dd can be more easily acquired using the physical quantity acquired by the physical quantity sensor 16 and the time difference Δt. In particular, in the embodiment described above, by performing correction of translating each pixel of the second spectral image IS2 in the direction opposite to the movement direction of the target 32 by a pixel amount corresponding to the positional shift amount Dd, it is possible to more easily and accurately correct the positional shift of the second spectral image IS2 with respect to the first spectral image IS1. Even when the movement speed V of the target 32 is changed and the physical quantity representing the relative movement is changed, the physical quantity representing the relative movement can be accurately acquired by the physical quantity sensor 16. By this, for example, even when the movement speed V of the target 32 is changed along the way, the positional shift amount Dd can be calculated with high accuracy, so that the positional shift amount of the second spectral image IS2 with respect to the first spectral image IS1 can be accurately corrected.

### B. Other Embodiments

### B-1 First Other Embodiment

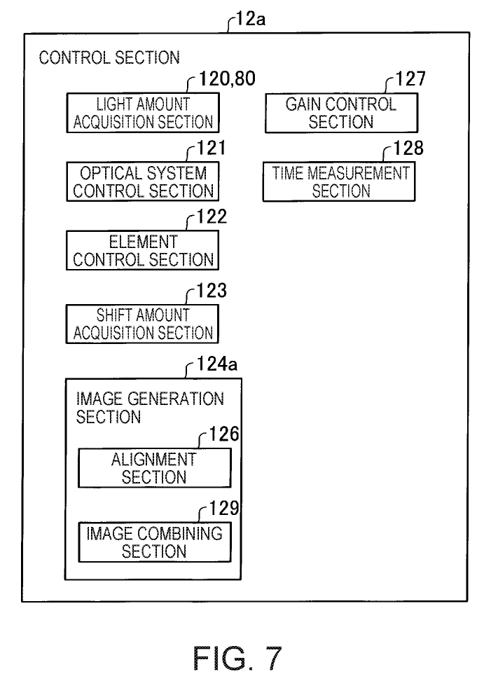

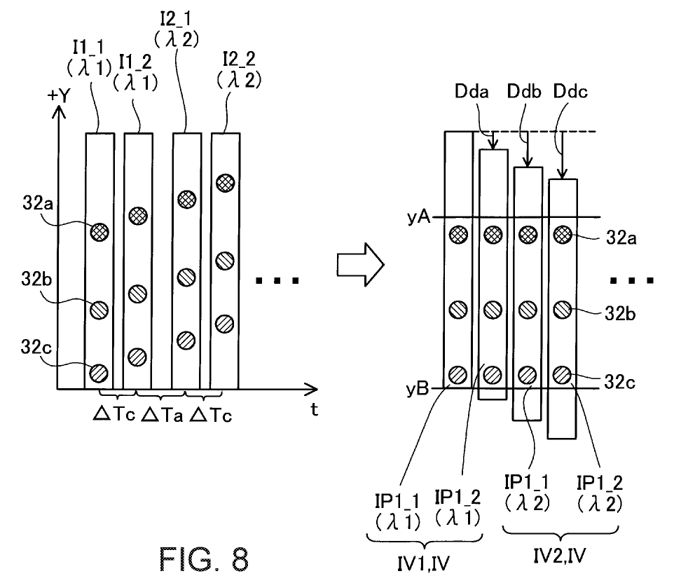

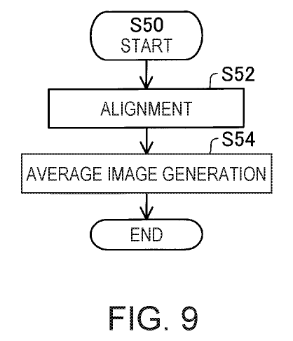

FIG. 7 is a diagram for explaining a control section 12a according to a first other embodiment. FIG. 8 is a diagram for explaining the first other embodiment of the generation process of the spectral image executed by the spectrometer 10. FIG. 9 is a flowchart of step S50 according to the first other embodiment. FIG. 7 is a view corresponding to FIG. 5 of the above embodiment. In the above embodiment, the imager 80 acquires one spectral image I1 to I4 for each of the measurement wavelengths λ1 to λ4 for the image group IG. In the first other embodiment, the imager 80 is different from the above-described embodiment in that a plurality of spectral images are acquired for each of the measurement wavelengths λ1 to λ4 with respect to the image group IG. In the first other embodiment, the measurement wavelength λ is four wavelengths of λ1 to λ4. In the first other embodiment, the image generation section 124a of the control section 12a newly includes an image combining section 129. Since the other configurations of the spectrometer 10 such as the spectroscopic element 20 are the same as those of the above-described embodiment and the first other embodiment, the description of the same configurations will be appropriately omitted.

As illustrated in FIG. 8, in the first other embodiment, the imager 80 acquires two spectral images one after the other for each measurement wavelength λ at different timings for the image group IG. That is, the imager 80 acquires the identical wavelength image as a spectral image of the same wavelength λ a plurality of times at different timings. For example, in step S20 shown in FIG. 5, the imager 80 acquires the identical wavelength image I1_1 for the measurement wavelength λ1, and then acquires the identical wavelength image I1_2 for the same measurement wavelength λ1. Next, in step S10, after the determination in step S30 in FIG. 5, the element control section 122 applies a drive voltage that corresponds to the measurement wavelength λ2 between the first drive electrode 24A and the second drive electrode 24B. Next, in step S20, the imager 80 acquires the identical wavelength image I2_1 of the measurement wavelength λ2 illustrated in FIG. 8, and then acquires the identical wavelength image I2_2 of the same measurement wavelength λ2. The spectrometer 10 repeatedly executes step S10 to step S30 illustrated in FIG. 5 for all the measurement wavelengths λ1 to λ4.

In the first other embodiment, the exposure time of the imager 80 for acquiring each image is set to be shorter than that in the above embodiment. Specifically, the exposure time of the first other embodiment is half the exposure time of the above embodiment. As illustrated in FIG. 8, the time difference in acquisition timing between the identical wavelength images is a time difference ΔTc.

In step S40 of the first other embodiment, the shift amount acquisition section 123 sets the spectral image I1_1 acquired first in the one image group IG obtained by imaging the same target 32 as the first spectral image IS1, and sets the remaining spectral images I1_2, I2_1,..., I4_2 as the second spectral images. IS2 Then, in step S40, the shift amount acquisition section 123 acquires the positional shift amount Dd of the second spectral image IS2 with respect to the position of the first spectral image IS1. In detail, similarly to the above-described embodiment, the shift amount acquisition section 123 acquires the positional shift amount Dd by multiplying the movement speed V of the target 32 acquired by the physical quantity sensor 16 by the time difference ΔT between the acquisition timing of the first spectral image IS1 and the acquisition timing of the second spectral image IS2. For example, in the first image group IG1, the positional shift amount Dda between the first spectral image I1_1 and the second spectral image I1_2 is obtained by multiplying the movement speed V by the time difference ΔTA. As illustrated in FIG. 8, the time difference ΔTc is the time difference ΔTc between the first spectral image I1_1 and the second spectral image I1_2. For example, in the first image group IG1, the positional shift amount Ddb between the first spectral image I1_1 and the second spectral image I2_1 is obtained by multiplying the movement speed V by the time difference ΔTB. The time difference ΔTB is the time difference ΔTc + ΔTa between the first spectral image I1_1 and the second spectral image I2_1.

After the positional shift amount Dd in one image group IG is acquired, then, as illustrated in FIG. 9, in the step S52, the alignment section 126 performs alignment between the first spectral image IS1 and the second spectral image. The processing content of step S52 is the same as the alignment of step S50 shown in FIG. 5 of the above embodiment. For example, the alignment section 126 performs alignment by translating, in the direction opposite to the movement direction of the target 32, the spectral image I1_2 of the first image group IG1 by a pixel amount corresponding to the positional shift amount Dda. For example, the alignment section 126 performs alignment by translating the spectral image I2_1 of the first image group IG1 by the pixel amount corresponding to the positional shift amount Ddb in the direction opposite to the movement direction of the target 32.

After alignment is performed for all the spectral images, as illustrated in FIG. 9, in step S54, the image combining section 129 acquires an average image IV obtained by averaging the plurality of identical wavelength images on which alignment was performed. Specifically, the image combining section 129 generates the average image IV by averaging the pixel values of the same pixels of the plurality of identical wavelength images I. For example, the image combining section 129 generates the average image IV1 by adding the pixel values of the pixels of the two identical wavelength images IV1_1 and IV1_2 that have been aligned and then dividing the sums by two. The image combining section 129 generates an average image IV for a plurality of identical wavelength images for a single measurement wavelength λ, and stores the generated average image IV in the storage section 14. By this, step S50 of the first other embodiment is completed.

According to the first other embodiment, the identical wavelength images I1_1, I1_2, I2_1, and I2_2 are acquired a plurality of times to generate the average image IV and, by this, the exposure time for acquiring the identical wavelength images I1_1, I1_2, I2_1, and I2_2 in one time can be shortened. This reduces the relative movement amount of the target 32 during exposure, thereby reducing the blur of the identical wavelength images I1_1, I1_2, I2_1, and I2_2. By generating the average image IV, it is possible to reduce the noise component and increase the S/N ratio.

In the first other embodiment, the number of the identical wavelength images I acquired by the imager 80 at the same wavelength λ is the same for each of the measurement wavelengths λ1 to λ4, but may be different in accordance with the measurement wavelengths λ1 to λ4. For example, at the same exposure time and the same amplification factor, the S/N ratio (Signal to Noise Ratio) of each of the spectral images I1 to I4 may be acquired in advance for each of the measurement wavelengths λ1 to λ4, or a known S/N ratio may be used, and the exposure time may be shortened and the number of identical wavelength images I may be set to be larger for the measurement wavelengths λ having a lower S/N ratio. In this way, the average image IV is generated by increasing the number of identical wavelength images I for a measurement wavelength λ that tends to have a large noise component and, by this, the noise component can be further reduced and the S/N ratio can be further increased.

### B-2 Second Other Embodiment

In each of the embodiments described above, in the generation process of the spectral image, the element control section 122 adjusts the dimension of the gap Gp so that the measurement wavelengths λ1, λ2, λ3, and λ4 are arranged in this order for one of the targets 32a to 32c to be measured, and after acquiring the first image group IG1, adjusts the dimension of the gap Gp so that the measurement wavelengths λ1, λ2, λ3, and λ4 are arranged in this order for the other targets 32b to 32dto be measured. However, the element control section 122 may execute the following first element control process and the second element control process with respect to the dimension of the gap Gp in the first direction. The first element control process is a process of, when the gap dimension G was gradually increased and has reached the second distance, gradually reducing the dimension of the gap Gp from the second distance to reach the first distance. That is, in the first element control process, when the gap dimension G is changed in the order of G4, G3, G2, and G1 at the time of acquiring the first image group IG1, then the gap dimension is changed in the order of G1, G2, G3, and G4 at the time of acquiring the second image group IG2 of the next target 32. The second element control process is a process of, when the gap dimension G was gradually decreased and has reached the first distance, gradually increasing the gap dimension G from the first distance to reach the second distance. That is, in the second element control process, when the gap dimension G is changed in the order of G1, G2, G3, and G4 at the time of acquiring the first image group IG1, the gap dimension is changed in the order of G4, G3, G2, and G1 at the time of acquiring the second image group IG2 of the next target 32.

According to the second other embodiment, since the time for changing the gap dimension G can be shortened, the time for acquiring a plurality of spectral images can be shortened. By this, a single target 32 can be positioned within the imaging region of the spectrometer 10 during the time for acquiring the plurality of spectral images I corresponding to the plurality of target measurement wavelengths λ. Therefore, the spectrometer 10 can more reliably acquire a plurality of spectral images corresponding to a plurality of target measurement wavelengths λ for one target 32.

### B-3 Third Other Embodiment

In each of the embodiments described above, the shift amount acquisition section 123 acquires the positional shift amount Dd by calculating the positional shift amount Dd using the movement speed V detected by the physical quantity sensor 16 and the time difference Δt, but this is not a limitation. For example, the storage section 14 may store the positional shift amount Dd for each second spectral image IS2 in advance. The shift amount acquisition section 123 may acquire the positional shift amount Dd stored in the storage section 14. For example, in a case where the transport speed of the transport section 30 is determined in advance and the time difference ΔT between the acquisition timings of the first spectral image IS1 and the second spectral image IS2 is known, then the transport speed, which is information regarding relative movement, and the time difference ΔT are multiplied and, by this, the positional shift amount Dd of the second spectral image IS2 with respect to the first spectral image IS1 can be calculated in advance and stored in the storage section 14.

According to the third other embodiment, the positional shift amount Dd can be acquired without constantly detecting the physical quantity representing the relative movement using the physical quantity sensor 16.

### C. Other Embodiments

The present disclosure is not limited to the above-described embodiments, and can be realized in various forms without departing from the gist thereof. For example, the present disclosure can be realized by the following aspects. The technical features in the above embodiments corresponding to the technical features in the aspects described below can be replaced or combined as appropriate in order to solve some or all of the problems of the present disclosure or in order to achieve some or all of the effects of the present disclosure. If the technical features are not described as essential in the present specification, the technical features can be deleted as appropriate.

(1) According to an aspect of the present disclosure, a spectrometer is provided. The spectrometer includes a spectroscopic element configured to change a wavelength of light to be transmitted and to spectrally disperse light from a target; an element control section configured to control operation of the spectroscopic element; an imager configured to receive the light transmitted through the spectroscopic element and to acquire at least one spectral image for each of a plurality of the wavelengths obtained by spectral dispersion, the imager acquiring a plurality of spectral images corresponding to the plurality of wavelengths for a target that moves relative to the imager at acquisition timings different from each other; a shift amount acquisition section configured to, using information on the relative movement, acquire a relative positional shift amount between a first spectral image that is one of the plurality of spectral images and a second spectral image that is another one of the plurality of spectral images; and a position alignment section configured to perform, using the positional shift amount acquired by the shift amount acquisition section, position alignment between the first spectral image and the second spectral image by correcting a position of the second spectral image with respect to a position of the first spectral image.

According to the aspect described above, the relative positional shift amount is acquired using information related to the relative movement and the position of the second spectral image is corrected with respect to the position of the first spectral image using the acquired positional shift amount, whereby the positional shift amount of the second spectral image with respect to the first spectral image can be corrected easily and accurately.

(2) The above aspect may be such that the imager acquires identical wavelength images as the spectral images of the same wavelength a plurality of times at different timings, the spectrometer further comprising: an image combining section configured to generate an average image by averaging the plurality of identical wavelength images on which the alignment has been performed.

According to the above aspect, the identical wavelength image is acquired a plurality of times and the average image is generated and, by this, it is possible to shorten the exposure time for acquiring the identical wavelength images at one time. This can reduce blurring of the identical wavelength image due to relative movement of the target during exposure. By generating the average image, it is possible to reduce the noise component and increase the S/N ratio.

(3) The above aspect may be such that the spectroscopic element includes a first substrate having a first reflective film and a second substrate having a second reflective film facing the first reflective film in a first direction via a gap and is an element configured to change wavelength of the transmitted light by changing a dimension of the gap in the first direction by displacing the second reflective film and in a case where the plurality of spectral images are acquired by changing wavelength of the transmitted light in a range in which the dimension in the first direction is equal to or greater than a first distance and equal to or less than a second distance, the element control section executes a first element control process of, when the dimension was gradually increased and has reached the second distance, gradually decreasing the dimension from the second distance to reach the first distance and a second element control process of, when the dimension was gradually decreased and has reached the first distance, gradually increasing the dimension from the first distance to reach the second distance.

According to the aspect described above, since the time for changing the dimension of the gap can be shortened, the time for acquiring a plurality of spectral images can be shortened.

(4) The above aspect may be such that the imager sets an amplification factor for amplifying a signal of the received light for each of the plurality of wavelengths obtained by spectral dispersion so as to reduce a difference in luminance between the plurality of spectral images for each of the plurality of wavelengths.

According to the aspect described above, the amplification factor is set for each of the plurality of wavelengths, and thus it is possible to reduce the difference in luminance between the plurality of spectral images.

(5) The above aspect may be such that the imager changes the number of the identical wavelength images to be acquired according to the plurality of wavelengths.

According to the above aspect, the average image is generated by increasing the number of identical wavelength images for a wavelength that tends to have a large noise component and, by this, it is possible to further reduce the noise component and further increase the S/N ratio.

(6) The above aspect may further include a physical quantity sensor configured to detect a physical quantity representing the relative movement and a time measurement section configured to detect a time difference between the acquisition timings, wherein the shift amount acquisition section acquires the positional shift amount using the physical quantity detected by the physical quantity sensor and the time difference detected by the time measurement section.

According to the aspect described above, for example, even when the movement speed of the target is changed and the physical quantity representing the relative movement is changed, the physical quantity representing the relative movement can be accurately acquired by the physical quantity sensor. By this, it is possible to accurately correct the positional shift amount of the second spectral image with respect to the first spectral image.

(7) The above aspect may further include a storage section that stores the positional shift amount for each second spectral image in advance, wherein the shift amount acquisition section acquires the positional shift amount calculated in advance using information on the relative movement stored in the storage section.

According to the aspect described above, the positional shift amount can be acquired without constantly detecting a physical quantity representing relative movement using a physical quantity sensor.

(8) The above aspect may be such that the relative movement is movement in one direction orthogonal to a vertical direction while maintaining a distance between the imager and the target in the vertical direction constant and the alignment section performs alignment between the first spectral image and the second spectral image by performing correction of translating each pixel of the second spectral image by a pixel amount corresponding to the positional shift amount.

According to the aspect described above, by translating each pixel of the second spectral image by the pixel amount corresponding to the positional shift amount, it is possible to more easily and accurately correct the positional shift amount of the second spectral image with respect to the first spectral image.

The present disclosure can be implemented in various forms other than the above. For example, it can be realized in the form of a spectrometer system, a method of controlling a spectrometer system, and the like.

What is claimed is:

1. A spectrometer comprising:
a spectroscopic element configured to change a wavelength of light to be transmitted and to spectrally disperse light from a target;
an element control section configured to control operation of the spectroscopic element;
an imager configured to receive the light transmitted through the spectroscopic element and to acquire at least one spectral image for each of a plurality of the wavelengths obtained by spectral dispersion, the imager acquiring a plurality of spectral images corresponding to the plurality of wavelengths for a target that moves relative to the imager at acquisition timings different from each other;
a shift amount acquisition section configured to, using information on the relative movement, acquire a relative positional shift amount between a first spectral image that is one of the plurality of spectral images and a second spectral image that is another one of the plurality of spectral images; and
a position alignment section configured to perform, using the positional shift amount acquired by the shift amount acquisition section, position alignment between the first spectral image and the second spectral image by correcting a position of the second spectral image with respect to a position of the first spectral image.

2. The spectrometer according to claim 1, wherein
the imager acquires identical wavelength images as the spectral images of the same wavelength a plurality of times at different timings,□the spectrometer further comprising:
an image combining section configured to generate an average image by averaging the plurality of identical wavelength images on which the alignment has been performed.

3. The spectrometer according to claim 1, wherein
the spectroscopic element includes a first substrate having a first reflective film and a second substrate having a second reflective film facing the first reflective film in a first direction via a gap and is an element configured to change wavelength of the transmitted light by changing a dimension of the gap in the first direction by displacing the second reflective film and
in a case where the plurality of spectral images are acquired by changing wavelength of the transmitted light in a range in which the dimension in the first direction is equal to or greater than a first distance and equal to or less than a second distance,
the element control section executes a first element control process of, when the dimension was gradually increased and has reached the second distance, gradually decreasing the dimension from the second distance to reach the first distance and a second element control process of, when the dimension was gradually decreased and has reached the first distance, gradually increasing the dimension from the first distance to reach the second distance.

4. The spectrometer according to claim 1, wherein
the imager sets an amplification factor for amplifying a signal of the received light for each of the plurality of wavelengths obtained by spectral dispersion so as to reduce a difference in luminance between the plurality of spectral images for each of the plurality of wavelengths.

5. The spectrometer according to claim 2, wherein
the imager changes the number of the identical wavelength images to be acquired according to the plurality of wavelengths.

6. The spectrometer according to claim 1, further comprising:
a physical quantity sensor configured to detect a physical quantity representing the relative movement and
a time measurement section configured to detect a time difference between the acquisition timings, wherein
the shift amount acquisition section acquires the positional shift amount using the physical quantity detected by the physical quantity sensor and the time difference detected by the time measurement section.

7. The spectrometer according to claim 1, further comprising:
a storage section that stores the positional shift amount for each second spectral image in advance, wherein
the shift amount acquisition section acquires the positional shift amount calculated in advance using information on the relative movement stored in the storage section.

8. The spectrometer according to claim 1, wherein
the relative movement is movement in one direction orthogonal to a vertical direction while maintaining a distance between the imager and the target in the vertical direction constant and
the alignment section performs alignment between the first spectral image and the second spectral image by performing correction of translating each pixel of the second spectral image by a pixel amount corresponding to the positional shift amount.
